(19) United States
(12) Patent Application Publication
(10) Pub. No.: US 2025/0322972 A1
(43) Pub. Date: Oct. 16, 2025

(54) NUCLEAR REACTOR PROVIDED WITH A CORE SUPPORT SYSTEM

(71) Applicant: NEWCLEO SA, Paris (FR)

(72) Inventors: Luciano CINOTTI, TORINO (IT); Norberto MEDA, TORINO (IT); Luigi VERNETTI, TORINO (IT); Giovanni CORSINI, TORINO (IT); Leonardo PRESCIUTTINI, TORINO (IT)

(73) Assignee: NEWCLEO SA, Paris (FR)

(21) Appl. No.: 18/873,461

(22) PCT Filed: Jun. 13, 2023
(86) PCT No.: PCT/IB2023/056083

§ 371 Date: Dec. 10, 2024

(30) Foreign Application Priority Data
Jun. 13, 2022 (IT) 102022000012476

(51) Int. Cl. G21C 13/04; G21C 5/06; G21C 5/08; G21C 5/10

(52) U.S. Cl. CPC G21C 13/04; G21C 5/06; G21C 5/08; G21C 5/10

(57) ABSTRACT

A nuclear reactor is disclosed. The nuclear reactor comprises a vessel closed at the top by a roof and housing a core, comprising a bundle of fuel elements. The core being supported by a lower support supporting a lower portion of the core below an active zone of the fuel elements; and an upper support supporting an upper portion of the core above the active zone of the fuel elements; the upper support is joined to the roof by a support structure extending from the roof and has an end element centrally open and internally provided with a plurality of jaws for vertical support and elastic radial constraint of the fuel elements.

### CROSS-REFERENCE TO RELATED APPLICATIONS

This Patent application claims priority from Italian Patent Application No. 102022000012476 filed on Jun. 13, 2022, the entire disclosure of which is incorporated herein by reference.

### TECHNICAL FIELD

The present invention relates to a nuclear reactor, in particular a fast nuclear reactor cooled by liquid metal or molten salts.

### BACKGROUND

It is known that fast-neutron nuclear reactors can be built with compact dimensions and with a core that can operate for several years without fuel replacement. This feature allows the construction of plants not provided with a replacement system and a spent fuel storage pool with the consequent advantages of (i) cost reduction of the plant and (ii) reduced risks of nuclear proliferation. Once the fuel charge is exhausted, the reactor core will be transported inside the reactor vessel to a centralized plant provided with spent fuel handling means. Clearly, transporting the entire vessel requires maximum compactness.

In the patent application PCT/IB2017/052606 a solution is described in which the fuel elements are mechanically supported by means of respective heads joined to each other and joined to an anchoring structure by support devices acting between adjacent fuel elements, or acting between fuel elements situated on the periphery of the core and the anchoring structure, which form an integral part of the heads of the fuel elements.

The patent application PCT/IB2017/052609 also describes solution in which the fuel elements are provided with expanders characterized by the mechanical coupling of high thermal expansion elements which engage alternatively with low thermal expansion elements to amplify the radial expansion of respective end elements which, when a given temperature is exceeded, engage with each other to distance the fuel elements from one another and operate a radial expansion of the core to widen the same by rotating the fuel elements around respective feet with respective heads that are spaced apart from one another.

These last two patents combined together allow the forming of a support system that acts in zones subjected to reduced neutron radiation and also allows the fuel elements to be spaced out in the event of exceeding the design temperature in order to cause the reactor to stop. However, the resulting solution does not allow also the housing of the heat exchangers and the pump on the vertical direction of the core, as would be desirable from the point of view of reactor compactness.

### SUMMARY

The object of the present invention is to provide a nuclear reactor, in particular a fast nuclear reactor cooled with liquid metal or molten salts, which overcomes the noted drawbacks of known solutions and has constructive and safety advantages.

The present invention therefore relates to a nuclear reactor, in particular a fast nuclear reactor cooled with liquid metal or molten salts, as defined in the attached claim 1 and, due to its auxiliary characteristics and plant configurations, in the dependent claims.

In summary, the present invention relates to a nuclear reactor, in particular a fast nuclear reactor, preferably cooled with heavy liquid metal or molten salts, in which the core is constrained axially and radially in the upper part and radially in the lower part by an upper support, supporting an upper portion of the core above the active zone of the fuel elements, and by a lower support, supporting a lower portion of the core below the active zone of the fuel elements, respectively. At least the upper support is carried by a support structure which, inside the reactor vessel, extends from the roof of the reactor so as to leave available the space above the core which can house a heat exchanger.

In a preferred embodiment, the support structure extending from the roof of the reactor branches into an upper core-constraining branch, provided with the upper support, and a lower core-constraining branch, provided with the lower support. Overall, the support structure looks like a double bottom cylinder with both bottoms incomplete. Said upper and lower bottoms constrain the core only at the two ends which are in a lower neutron flux zone since being distant from the active part of the core due to the upper gas region and the lower gas region which are interposed.

In other embodiments, the two branches of the support structure, instead of integrally joined to one another, are formed by respective separate bodies, both supported by the roof of the reactor, for example concentric one relative to the other (with the branch carrying the upper support radially within the branch carrying the lower support). Or, while the upper support is carried by the support structure suspended from the roof of the reactor, the upper support is carried by a body which extends from below, from a bottom wall of the main vessel of the reactor.

The upper cylindrical portion of the support structure above the upper core-constraining bottom is perforated to allow the passage of cold primary cooling fluid at the exchanger outlet and channelling thereof towards the inlet of the core in the annular conduit delimited externally by the reactor vessel and internally by the support structure.

The lower support bottom supporting the core internally reproduces the external profile of the core to be contained. The upper support bottom supporting the core internally comprises a plurality of jaws, preferably six in number for a core having a hexagonal section, for containing the heads of the fuel elements which interact with an end element forming part of the upper support bottom. The jaws comprise a movable element which acts on the heads of the fuel elements by means of elastic thrust elements formed for example by helical springs or leaf springs. The heads of the fuel elements internally contain expanding bimetallic elements which, when the design temperature is exceeded, space the heads of the fuel elements overcoming the reaction of the elastic elements of the jaws.

The upper support supporting the core is provided with cavities for housing cams for vertical support of the fuel elements and with an elastic radial containment system for the heads of the fuel elements, which in accidental conditions of excessive heating of the core interacts with a system of bimetallic spacing expanders for the heads of the fuel elements to cause reactor shutdown; the lower support structure ends with a hexagonal outline for radial containment of the feet of the fuel elements.

### BRIEF DESCRIPTION OF THE DRAWINGS

The invention is described in detail in the following non-limiting embodiment with reference to the figures of the attached drawings, wherein:

FIG. 1 is a schematic view in longitudinal section of a nuclear reactor according to the invention;

FIG. 2 is a view on an enlarged scale of a detail of the nuclear reactor of FIG. 1;

FIG. 3 is a simplified top view according to the plane of trace I-I in FIG. 2 and shows in particular a vertical support system of the fuel elements;

FIG. 4 is an enlarged scale view of a detail of FIG. 3;

FIG. 5 is a partial simplified view from above according to the plane of trace II-II in FIG. 2 and shows in particular a system for horizontally constraining the fuel elements;

FIG. 6 is a schematic view of an alternative of the system shown in FIG. 5;

FIG. 7 is a partial simplified view from above according to the plane of trace III-III in FIG. 2 and shows in particular a release device of the elastic compression system of the fuel elements;

FIGS. 8A and 8B are a simplified perspective view and an exploded partial perspective view of a thermal expander used in the nuclear reactor of the invention, respectively.

### DESCRIPTION OF EMBODIMENTS

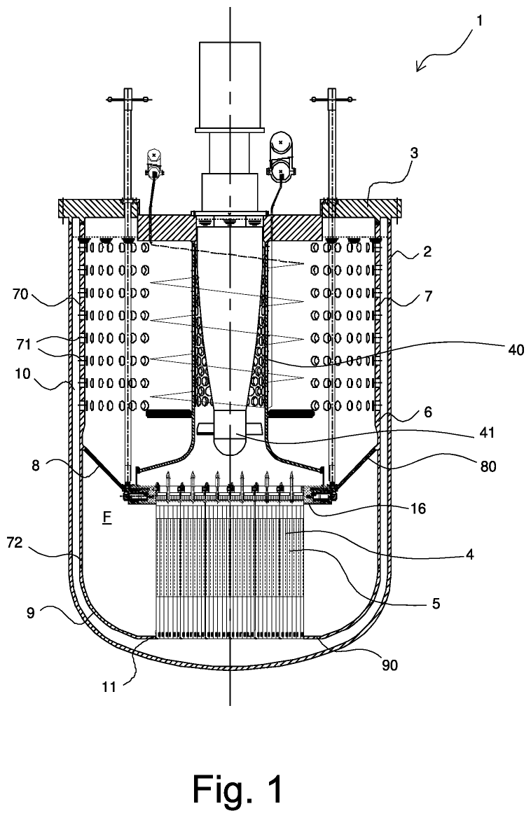

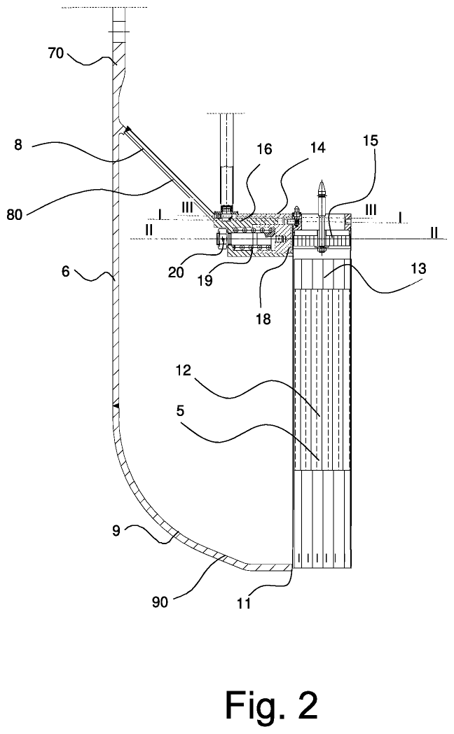

With reference to FIGS. 1 and 2, a nuclear reactor 1 comprises a main vessel 2 containing a primary cooling fluid F and closed at the top by a roof 3.

The vessel 2 internally contains a core 4, formed by a plurality of fuel elements 5 and immersed in the primary fluid F, and a support structure 6 supporting the core 4 carried by the roof 3.

For example, but not necessarily, the fuel elements 5 have a hexagonal cross section and are arranged next to one another to form, as a whole, a core 4 which in turn has a substantially hexagonal shape.

In the preferred embodiment illustrated, the support structure 6 is shaped as a double bottom shell and has a substantially cylindrical lateral wall 7 supported by the roof 3 and an upper bottom 8 and a lower bottom 9 which branch off radially inside the lateral wall 7 and are vertically spaced from one another.

The lateral wall 7 comprises a perforated upper portion 70, positioned above the upper bottom 8 and provided with a plurality of through radial holes 71 which allow the passage of primary fluid F; and a lower portion 72, positioned below the upper bottom 8 and from which the lower bottom 9 branches off.

The lateral wall 7 and the bottom 9 together with the vessel 2 delimit an annular conduit 10 for feeding the core 4.

The bottom 8 defines an upper support 80 supporting the core 4 and the bottom 9 defines a lower support 90 supporting the core. Preferably, the support 80 is configured to axially (vertically) support the core 4 and provide an elastic radial constraint of the core 4, whereas the support 90 is configured to define a radial constraint of the core 4.

In particular, the bottom 9 has a central through opening delimited by a peripheral edge 11 having a profile corresponding to the external perimeter of the core 4 so as to form a radial constraint of the core 4.

The bottom 8 has a central through opening delimited by an end element 16 internally comprising a plurality of jaws 14 for vertical support and elastic radial constraint of the fuel elements 5.

Advantageously, to reduce the neutron damage of the bottom 8 and of the bottom 9, the bottom 8 and therefore the support 80 act on an upper portion of the core 4 above an active zone 12 of the fuel elements 5; and the bottom 9 and the support 90 act on a lower portion of the core 4 below the active zone 12 of the fuel elements 5. Outside the active zone 12 of the fuel elements 5, in fact, the neutron flux is lower, also because the opposite ends of the fuel rods contain gas and are free of fuel.

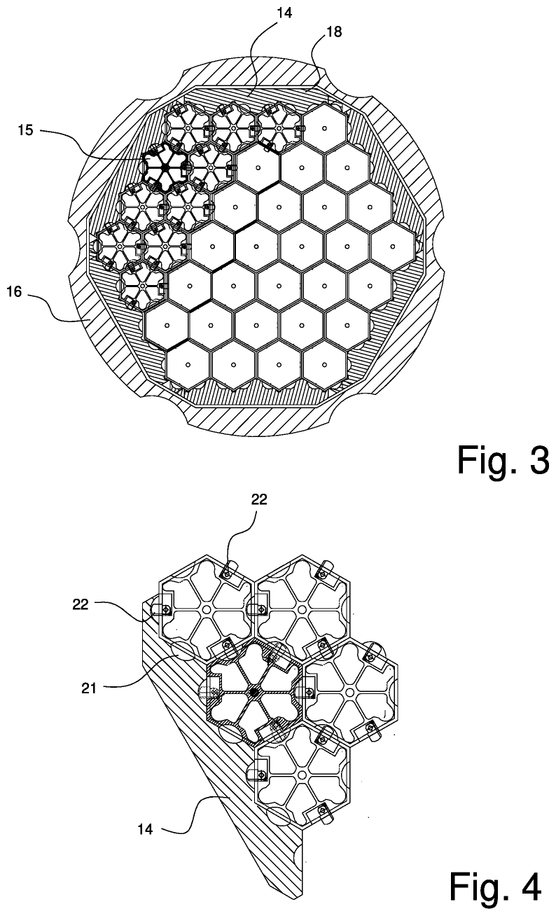

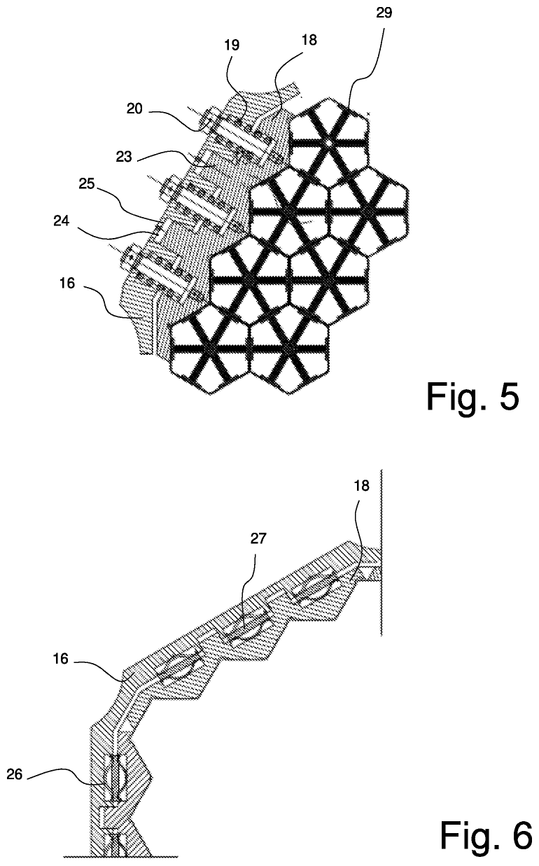

With reference also to FIGS. 3-5, the jaws 14, for example six in number for a core 4 having a hexagonal section, are supported in a movable manner by the end element 16 and are movable to radially clamp the heads 15 of the fuel elements 5. The jaws 14 act on the heads 15 of the fuel elements 5 by means of pushing elements 18 provided with elastic members 19 such as, for example, springs, in particular coil springs, and elements 20 for pre-tensioning the elastic members 19.

The jaws 14 vertically support the fuel elements 5 of the outermost crown of the core 4 by means of cavities 21 on which cams 22 of the fuel elements 5 engage. The fuel elements 5 of the outermost crown in turn vertically fix the fuel elements 5 belonging to the innermost crowns with the same cam system 22, as described in the patent application PCT/IB2017/052606.

The jaws 14 are forced against the heads 15 of the fuel elements 5 by the thrust elements 18 and are guided in their compressive action by one or more cylindrical bodies 23, or of other shape, which slide in respective housings 24 of the end element 16, communicating hydraulically, by means of calibrated holes 25, with the primary fluid F. The calibrated holes 25 connect the inside of the housings 24 with the mass of primary fluid F so as to allow expansion of the core 4 and also define a damping system for possible seismic shocks.

In FIG. 6, an alternative solution of the jaws 14 is shown, in which the pushing elements 18 which press on the heads 15 of the fuel elements 5 are provided with elastic members 26 in the form of leaf springs which, when horizontally engaged by the force due to the thrust of the heads 15 of the fuel elements 5, bending occurs and the ends thereof slide along respective supports 27.

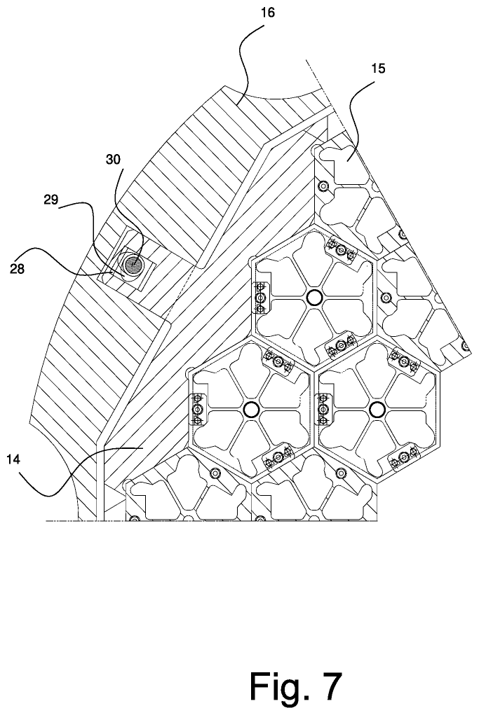

FIG. 7 illustrates a detail of a jaw 14, in which a hole 28 of a suitable shape (for example rectangular) is made in the central part and at the radial end. Inside the hole 28 a release cam 29 is arranged, integral with the end element 16 and operated by an operation shaft 30 which can be rotated to move the jaw 14 inside the hole 28, selectively reducing/increasing the compression action exerted by the jaws 14 on the heads 15 of the fuel elements 5.

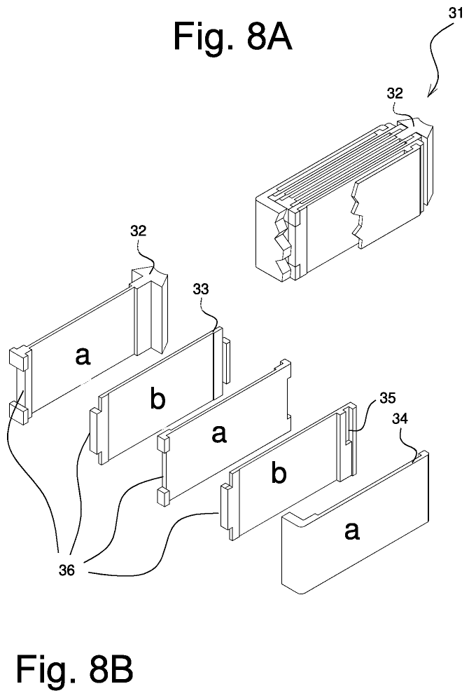

With reference to FIGS. 8A, 8B, each fuel element 5 is provided, on the head 15 thereof, with a plurality of thermal expanders 31 positioned on respective sides of the fuel element 5 (for example, six thermal expanders in the case of fuel elements 5 having a hexagonal section), similarly to what is shown in the patent PCT/IB2017/052609.

Each thermal expander 31 (for example of the six belonging to each head 15 of the fuel elements 5) is formed by first elements “a” with a high coefficient of thermal expansion alternated with second elements “b” with a low coefficient of thermal expansion; in particular, the thermal expander 31 comprises a central expander element 32, with greater thermal expansion, which articulates on opposite sides to respective lateral expander elements 33 having less thermal expansion, in turn coupled to other elements with greater thermal expansion and so forth ending up with respective box elements 34, which complete the whole and are hooked together due to a joint 35.

Thermal expanders of this type are already known from PCT/IB2017/052609 where the spacing occurs by deformation of the fuel element. In addition to what is already provided in PCT/IB2017/052609, the thermal expanders 31 have return joints 36 which also allow the thermal expanders 31 to radially withdraw to guarantee expansion according to the temperature.

The nuclear reactor 1 then comprises a heat exchanger 40 (FIG. 1) for removing heat from the primary fluid F via a secondary fluid circulating in the heat exchanger 40. According to the invention, the heat exchanger 40 is arranged centrally above of the core 4. Thanks to the support structure 6, in fact, the space above the core 4 is available to house the heat exchanger 40.

Advantageously, then, the heat exchanger 40 is an annular exchanger which internally houses a pump 41 for circulating the primary fluid F in the nuclear reactor 1.

In this way, the heat exchanger 40 is positioned centrally above the core 4 inside the upper perforated portion 70 of the support structure 6 provided with radially through holes 71 to allow the passage of primary fluid F exiting the heat exchanger 40 and channelling thereof towards the inlet of the core 4 in the annular conduit 10 delimited externally by the vessel 2 and internally by the support structure 6.

Finally, it is understood that further modifications and variations can be made to the nuclear reactor described and illustrated herein which do not go beyond the scope of the appended claims.

1. A nuclear reactor, comprising a vessel closed at the top by a roof and housing a core comprising a bundle of fuel elements and immersed in a primary fluid for cooling the core; and a heat exchanger for removing heat from the primary fluid via a secondary fluid circulating in the heat exchanger; the core being supported by a lower support supporting a lower portion of the core below an active zone of the fuel elements and by an upper support supporting an upper portion of the core above the active zone of the fuel elements; wherein the upper support is joined to the roof by a support structure extending from the roof and having an end element centrally open and internally provided with a plurality of jaws for vertical support and elastic radial constraint of the fuel elements.

2. The nuclear reactor according to claim 1, wherein the support structure is shaped as a double bottom shell and comprises a substantially cylindrical lateral wall supported by the roof and an upper bottom and a lower bottom extending radially inwards from the lateral wall and vertically spaced apart from each other; the lower bottom having a central opening delimited by a peripheral edge defining said lower support for radial constraint of the fuel elements of the core; the upper bottom being provided with said end element internally comprising the plurality of jaws for vertical support and elastic radial constraint of the fuel elements.

3. The nuclear reactor according to claim 1, wherein the heat exchanger is positioned centrally above the core inside an upper portion, positioned above the upper support and provided with radially through holes to allow the passage of primary fluid exiting from the heat exchanger and channeling thereof toward an inlet of the core in an annular conduit delimited externally by the vessel and internally by the support structure.

4. The nuclear reactor according to claim 1, wherein the jaws are supported, via respective bodies, by said end element and support vertically the fuel elements via respective cavities engaged by respective cams which are part of respective fuel elements.

5. The nuclear reactor according to claim 4, wherein the fuel elements have respective upper heads, positioned above the active zone of the fuel elements, and the jaws compress radially said heads by means of pushing elements operated by elastic members.

6. The nuclear reactor according to claim 4, wherein said bodies are housed in respective housings provided with calibrated holes which connect the inside of the housings with the primary fluid and allow expansion of the core and also define a damping system for possible seismic loads.

7. The nuclear reactor according to claim 4, wherein each fuel element is provided, on the head thereof, with a plurality of thermal expanders arranged on respective sides of the fuel element; each thermal expander comprising first high thermal expansion coefficient elements alternated with second low thermal expansion coefficient elements; the first and second expansion coefficient elements of the thermal expanders being articulated with one another by return joints that ensure also the return to the initial position as the temperature decreases.

8. The nuclear reactor according to claim 1, wherein the end element has release cams cooperating with respective jaws; each release cam being operated by an operation shaft to be rotated and push a jaw, selectively reducing and increasing the compression action exerted by the jaws on the heads of the fuel elements.

9. A nuclear reactor, comprising:
a vessel closed at the top by a roof;
a core housed by the vessel, the core comprising a bundle of fuel elements and immersed in a primary fluid for cooling the core;
a heat exchanger for removing heat from the primary fluid;
a lower support supporting a lower portion of the core below an active zone of the fuel elements; and
an upper support supporting an upper portion of the core above the active zone of the fuel elements, wherein the upper support is joined to the roof by a support structure extending from the roof, the upper support comprising an end element centrally open and internally provided with jaws for vertical support and elastic radial constraint of the fuel elements.

10. The nuclear reactor of claim 9, wherein the heat exchanger comprises a secondary fluid circulating therein.
